(19) United States
(12) Patent Application Publication
(10) Pub. No.: US 2017/0341899 A1
(43) Pub. Date: Nov. 30, 2017

(54) BOOKLET PRODUCTION

(71) Applicant: Watkiss Automation Limited, Bedfordshire (GB)

(72) Inventor: Michael Watkiss, Bedfordshire (GB)

(21) Appl. No.: 15/606,135

(22) Filed: May 26, 2017

(30) Foreign Application Priority Data
May 27, 2016 (GB) GB 1609403.9

(51) Int. Cl. B65H 45/16; B42C 19/02

(52) U.S. Cl. CPC B65H 45/164; B65H 45/165; B65H 45/167; B42C 19/02; B65H 2511/13; B65H 2701/13212; B65H 2301/51232

(57) ABSTRACT

An apparatus for treating a stack of sheets of sheet material includes a means for moving the stack of sheets of sheet material towards a first and second fold roller means. The first and second fold roller means are arranged to assist with folding of the stack of sheets of sheet material. The apparatus also includes a first and a second clamping jaw defining a gap. The first and second clamping jaws are arranged to be movable relative to each other to increase and decrease the gap for selective application of a clamping force to the stack of sheets of sheet material having passed between the first and second fold roller means. The first and second fold roller means are mounted in a manner allowing for an increase and decrease in separation and thus between a stack-guiding configuration and a stack compressing configuration.

### CROSS REFERENCE TO RELATED APPLICATION

This application claims the benefit of UK Patent Application GB 1609403.9 filed May 27, 2016 and titled “BOOKLET PRODUCTION”, the contents of which are hereby incorporated by reference in their entirety.

### BACKGROUND

This invention relates generally to methods of, and apparatus for, producing booklets and the like, and is also concerned with booklets and the like when produced by these methods. The term “booklet” used hereinafter is intended to cover any set of folded sheets which are stitched or stapled along an axis, which are glued, or which are simply folded. The term “booklet” is therefore intended to include items such as brochures, pamphlets, manuals and the like.

Customarily, the folding of a set of up to perhaps 30 or so sheets in a stitcher/folder machine results in the finished product having a spine with a convex end surface and sheets having a distinct outward bow adjacent the spine. This means that the booklet tends to open out, giving it a less attractive appearance, and also makes it more difficult to stack a number of the booklets for storage and transportation purposes because they will not lie “flat”. One cannot stack a large number of such booklets all with the spine on the same side, because the stack becomes lop-sided. One has to stack the booklets with some spines on one side and some on the other, in order to equalise the stack. Even then, the outward bow makes the stack higher than it need be for the number of booklets involved.

GB-A-2360013 describes a method of treating a booklet of sheets folded to create a curved spine, and an apparatus for carrying out the method. A folded booklet is clamped adjacent its spine between clamping jaws which extend along the length of the spine and have respective longitudinal ribs which engage the booklet adjacent the spine. The booklet is fed through the jaws into a position in which it abuts a stop plate and a portion adjacent the spine protrudes beyond the jaws. The final position is determined by the stop plate. After withdrawal of the stop plate, a forming means is passed along the length of the protruding portion to flatten the curved spine of the booklet.

GB-A-2401820 describes another system and method of treating the booklet of sheets which is first folded along an axis to form a booklet having a curved spine and for introduction to clamping jaws.

Whilst satisfactory from many points of view, the apparatus and methods of GB-A-2360013 and GB-A-2401820 are subject to the potential limitation/disadvantages that they can be relatively slow in operation and are not suited to the production of booklets with very few sheets. The lack of such adaptability can therefore introduce processing delays when used in relation to printing devices in so far as the booklet producing apparatus may not be able to receive and process a stack of sheets as quickly as they can be produced by the printer. Such limitations can affect the appearance of thinner booklets in particular that can be produced by the folding apparatus, and/or the speed of operation of the folding apparatus and booklet producing apparatus in which the folding apparatus may form an integral part.

### BRIEF DESCRIPTION

The present invention seeks to provide for a system for producing booklets having advantages over known such systems and, in particular, a system which is readily adaptable to the number of sheets required for each booklet, or as found in each stack, so as to efficiently integrate the booklet producing process with other document-producing processes such as printing.

According to an aspect of the present invention, there is provided an apparatus for treating a stack of sheets of sheet material, comprising means for moving the stack of sheets of sheet material towards first and second roller means, the roller means being arranged to assist with folding of the stack of sheets of sheet material, first and second clamping jaws defining a gap therebetween and arranged to be movable relative to each other to increase and decrease the gap for selective application of a clamping force a stack of sheets having passed between the roller means, wherein the first and second roller means are mounted in a manner allowing for an increase and decrease in separation therebetween and thus between a stack-guiding configuration and a stack compressing configuration.

Advantageously, a reciprocable blade provides the means for moving the stack towards the fold roller means and can also be movable into and out of the gap. During its stroke of movement towards the fold roller means and the said gap, the blade contacts the stack to initiate folding of the sheets about its leading edge to form the booklet. Advantageously, the blade has a longitudinal groove in its lower edge.

Preferably, the apparatus includes sheet-feeding means for feeding a stack of sheets into a position to be contacted by the blade during its stroke of its movement towards the roller means and the gap.

Advantageously, the sheet-feeding means can be arranged to feed the stack of sheets into the said position in a direction substantially perpendicular to the direction of insertion.

Sensor means can advantageously be provided so as to determine the thickness of the stack, i.e. number of sheets within the stack, and thereby determine the subsequent mode of operation of the apparatus.

In one mode, in the final position of the stack of sheets, the spinal portion lies between the jaws and the clamping force of the jaws has the effect of finishing the shape of the spinal portion of the booklet.

This is particularly suited to booklets having relatively few sheets, for example 10 or slightly fewer, or booklets of any number of sheets having loop staples.

In another mode, in the final position of the stack of sheets, the spinal portion protrudes from the clamping jaws by a predetermined distance in the direction of insertion, the apparatus including a forming means which is displaceable in the longitudinal direction of the spinal portion to exert pressure against the curved end surface portion and thereby produce a flattening of the curved end surface.

In yet a further mode, and one which is suited to booklets having very few, and for example in the order of 2-5, sheets, the separation between the fold roller means is reduced so that they apply a compressive force to the sheets introduced by the blade, which now functions as a fold blade, and as they pass through towards the now open jaws.

In this manner, the jaws remain open, preferably to the maximum extent, so as not to interfere with the passage of a booklet having been compressed and fully folded by the said fold roller means.

The clamping jaws, and or the roller means can be movable simultaneously and symmetrically about the mid-point of the gap or separation.

Advantageously, the face of each jaw which contacts the stack of sheets is a surface of a resiliently-deformable material.

The material is preferably a synthetic rubber material which preferably has a Shore A hardness of from 50 to 90, more preferably from 70 to 80.

As will be appreciated therefore, the fold roller means can, in one configuration, serve as rotatable guide rollers located adjacent each clamping jaw and positioned to guide the sheets into the gap between the jaws during insertion and for subsequent compression by the jaws. In another configuration, the fold roller means, when located closer together, and even in gentle contact, can serve as compression rollers for forming the folded booklet which then passes through the jaws. The fold roller means can be arranged to rotate freely through contact with the sheets as they function as guide rollers whereas, when functioning as fold rollers, the fold roller means can be driven not only to fold the sheets but also to deliver the folded booklet through the apparatus.

The invention is particularly advantageous in that the apparatus can be arranged to produce a variety of accurately folded, and readily stackable, booklets irrespective of the number of sheets involved. This can serve to limit the operational delay that might otherwise be imparted by known sheet folding apparatus within a booklet forming process.

The fold roller means are preferably restrained against rotation in the direction opposite to that in which they are rotated by the sheets during insertion.

### BRIEF DESCRIPTION OF DRAWINGS

The invention will now be described further hereinafter, by way of example only, and with reference to the schematic drawings of this specification, in which:

FIG. 1 shows a stack of sheets after folding and insertion into the clamping jaws of apparatus embodying the present invention;

FIG. 2 shows the passage of a roller to deform the spine of the booklet prepared as shown in FIG. 1;

FIG. 3 shows a thinner stack of sheets after folding and insertion into the clamping jaws of apparatus embodying the present invention arranged for an optional mode of operation of an embodiment of the invention; and

FIG. 4, FIG. 5, FIG. 6, FIG. 7, and FIG. 8 show the operating sequence of apparatus embodying the present invention and according to a further mode of operation.

The apparatus shown in the drawings is shown only schematically, to illustrate the sequence of movements involved in carrying out these modes of operation of the invention.

### DETAILED DESCRIPTION

A first mode of operation is now described although it should be appreciated that there are various modes that can share similar characteristics.

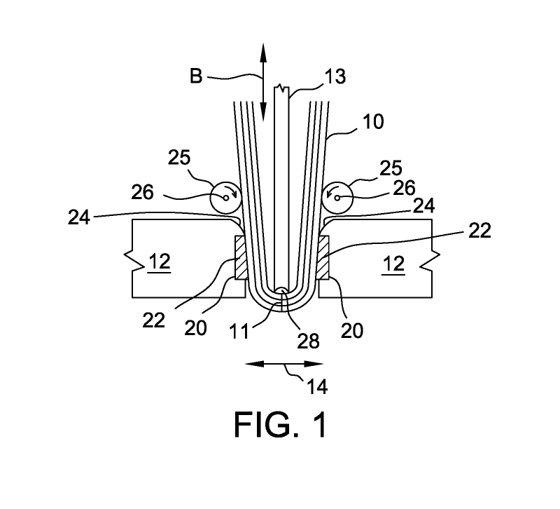

As shown in FIG. 1, the booklet is in the process of formation from a stack 10 consisting of a plurality of sheets of paper or other material stitched or stapled at one or more positions along an axis 11 to hold the sheets together and maintain them in register. The number of sheets in the stack is shown only schematically: the actual number is usually from 2 to 60 but is not limited to this range. The number of sheets present, and thus the thickness of the stack 10, can be a primary factor in determining which configuration of apparatus embodying the present invention is employed. The stack 10 has previously been fed by way of a feed mechanism (not shown) in a direction perpendicular to the direction of passage through the folding means, into a position above a pair of open clamping jaws 12. The clamping jaws 12 are elongate bars which extend the length of the set of sheets 10 (i.e. perpendicularly to the plane of the drawing sheet: FIG. 1 shows an end view only). The jaws 12 are movable towards and away from each other so that a gap 14 defined between the jaws becomes correspondingly smaller and larger, And with the smaller gap been employed during clamping/compression of the spine region of the folded stack of sheets.

Each jaw 12 has in its end face a rectangular-section recess 20 which receives an insert 22 which is made from a resiliently deformable silicone rubber material having a Shore A hardness of about 70 to 80. It has been found that a material of this hardness does not damage the staples or stitches of a stapled or stitched stack of sheets during subsequent processing. It is believed that materials of Shore A hardness values in the range of from about 50 to about 90 are also suitable.

The nature of the material of the inserts 22, and its Shore A hardness, is chosen in accordance with various factors which include: the need to be hard enough to grip the sheets of paper as described below; the need to be sufficiently soft to prevent the staples or stitches of stapled or stitched stacks of paper cutting into the sheets of the stack; and the need to be sufficiently resiliently deformable in compression to function as described below.

The upper edges of the jaws 12 are chamfered as indicated at 24 to facilitate insertion of the stack of sheets therebetween. A roller 25 mounted for rotation on an axle 26 is positioned above each jaw. As with the jaws 12, the rollers 25, which comprise fold rollers, are mounted so as to be movable towards and away each other so as to adjust the separation there-between. The fold rollers 25 are of course also elongate and extend the length of the set of sheets (i.e. perpendicularly to the plane of the drawing sheet). The function of the fold rollers 25 is described later.

A reciprocable blade 13 is positioned above the mid-point of the gap 14 and is movable up and down in the direction of the arrow B. The blade 13 can include a longitudinal groove 28 in its lower edge. On the downward stroke of its movement as shown in FIG. 1, the blade 13 forces the stack of sheets down between the jaws 12, thereby folding the sheets about the axis 11 and forming a booklet. During this downward movement of the blade 13, the groove 28 receives the staples or stitches of the stack of sheets. This assists in location of the blade on the stack 10 and in centralisation of the stack in the gap 14. The groove 28 also prevents damage to the staples or stitches. The fold rollers 25, as illustrated in FIG. 1 are in a guide configuration in which they can assist in guiding the stack of sheets into the gap 14. The end point of the downward stroke of movement of the blade 13 determines the final position of the folded stack of sheets relative to the jaws 12. This position is adjustable by adjustment of the stroke of the blade 13.

In FIG. 1, when the blade 13 has reached the end point of its downward stroke, and the folded stack of sheets is in its required position, the stack of sheets is shaped as shown and which is that of a “U” but with its arms somewhat divergent. From this position, the blade 13 begins its upward stroke, during which the folded stack of sheets remains in its position shown in FIG. 1 relative to the jaws 12 determined by the lower limit position of the blade 13. The outward flaring of the sheets, the surface friction between the sheets and the rubber inserts 22 and the fold rollers 25, all contribute the sheets being held in this position. Thus, as the blade 13 is withdrawn from between the folded sheets, the sheets remain in a position relative to the jaws 12 defined by the end point of the downward stroke of the blade 13. The jaws remain in their open position throughout this procedure as illustrated in FIG. 1.

It will be noted that the lower end-point of the movement of the blade 13 is chosen such that, in the position of the folded sheets shown in FIG. 1, the lowermost part of the stack of sheets protrudes below the lower edges of the jaws 12. This is not necessarily the case however and, in this final position of the sheets, determined by the blade 13, the lowermost part of the stack may be aligned with the lower edges of the jaws 12 or may even lie above their lower edges.

From the position shown in FIG. 1, the jaws 12 can be moved towards each other until a relatively high clamping force—(about 100 lbf or 450 N) is exerted on the folded sheets. This movement of the jaws brings about a deformation of the folded stack of sheets in the region adjacent the fold. It is important that the stack of sheets 10 is firmly gripped by the clamping jaws to prevent any relative movement of the sheets during this movement of the jaws. The end surface of the protruding portion of the stack of sheets is still convex in shape at this stage.

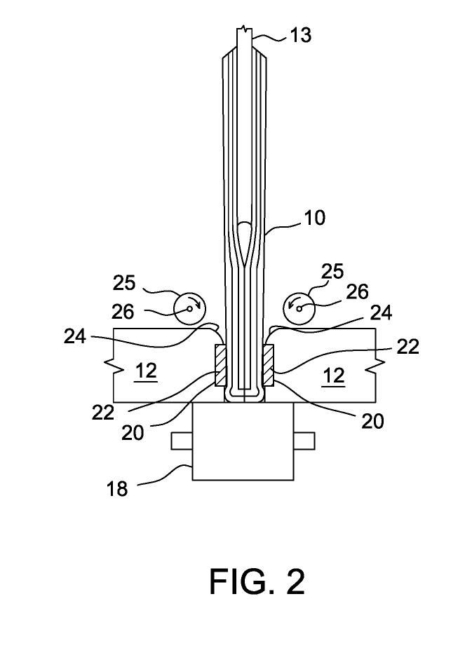

Once the booklet of sheets has been firmly gripped by the clamping jaws 12, a forming roller 18 is arranged to travel the length of the clamping jaws, below the jaws, thereby compressing and deforming the convex spine of the sheets into a flattened shape, in which the convex spine is deformed into the space formed beneath the inserts 22, above the roller 18 and between the jaws 12. This is shown in FIG. 2. In its passage beneath the clamping jaws 12 the forming roller 18 is almost in contact with the jaws. This is an important feature in producing the required effect when a relatively thick booklet is to be formed. The roller 18 thus exerts a substantial upward pressure against the spine of the folded sheets in its passage along the length of the jaws. Depending for example upon the number of sheets and the materials used, the forming roller 18 may make a single pass or more than one pass along the length of the spine in order to create the desired flattening of the spine.

When the forming roller 18 has performed its function it is returned to its inactive position at one end of the jaws. The jaws 12 are then opened to permit the booklet thus formed to be ejected by a further downward movement of the blade 13.

In accordance with another mode of operation more suited to booklets having relatively few sheets, for example 10 or slightly fewer, the forming roller 18 is not employed.

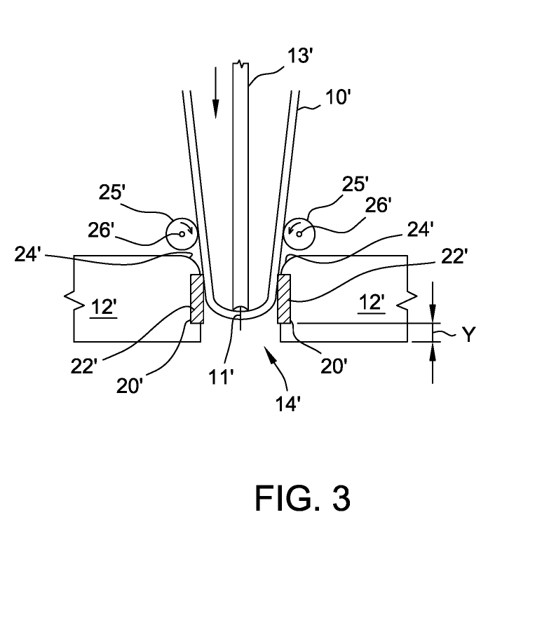

In the second mode of operation, and as illustrated with reference to FIG. 3, the stack 10′ of sheets is inserted between the jaws 12′ to a depth which is generally less than the depth in the first mode of operation. The fold rollers 25′ rotate about their axes 26′ in a manner serving to guide the folding stack 10 in between the jaws 12′. The depth is again determined by the end-point of the downward stroke of the movement of the blade 13′. The end-point can be determined by adjustment of the blade 13′ and is chosen such that, in the final position of the folded stack of sheets, the lowermost edge of the curved spinal portion of the sheets lies no lower than the lowermost edge of the inserts 22′. The lowermost edge of the curved spinal portion therefore lies above the lowermost edges of the jaws 12′ by a distance “y” shown in FIG. 3. The gap 14′ of separation between the jaws 12′ is again close enough to hold the folding stack 10′ therebetween until such time as the jaws 12′ move together to compress the spine of the forming booklet.

The depth of insertion is controlled by the movement of the blade 13′. There is again no stop plate.

It will be seen that, for the initial position of the stack shown in FIG. 3, the lowermost edge of the spinal portion is aligned with the lower edges of the inserts 22′ in the recesses 20′ in the jaws 12′.

The second mode of operation differs from the first in that no forming roller is used to deform and flatten the spine of the booklet. Instead, the booklet is simply subjected to a clamping force (again about 100 lbf or 450 N) as the gap 14′ reduces and the jaws 12′ close on the booklet. The resulting deformation between the jaws produces a reshaping of the spinal portion and a final booklet having much reduced outward bowing of the sheets. Although the end surface of the spinal portion retains its convex shape, the faces of the final booklet are much flatter adjacent the spine and the booklets can again be easily stacked one on another, with their spines all at the same side.

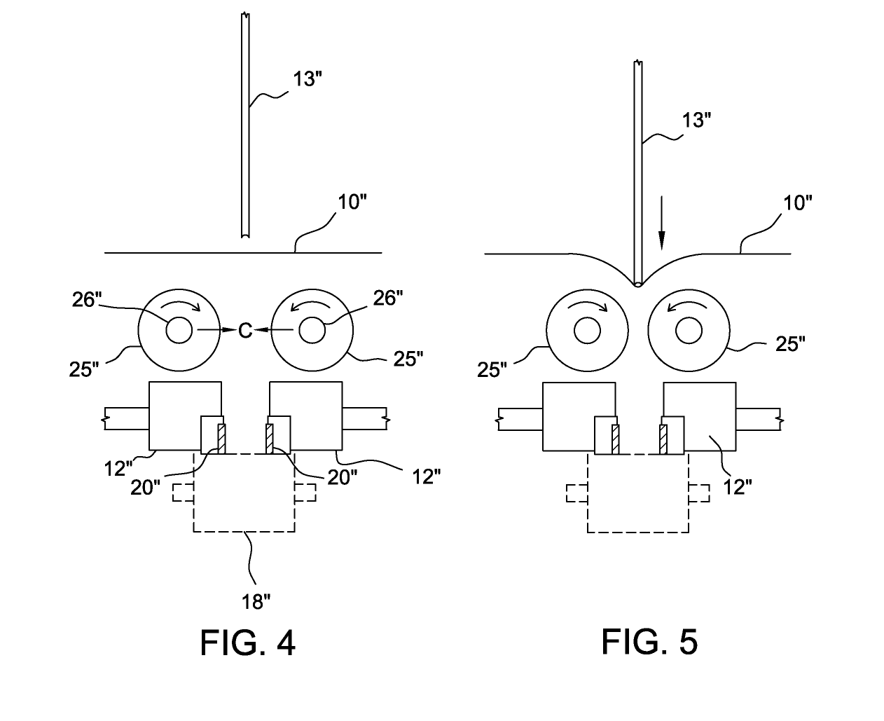

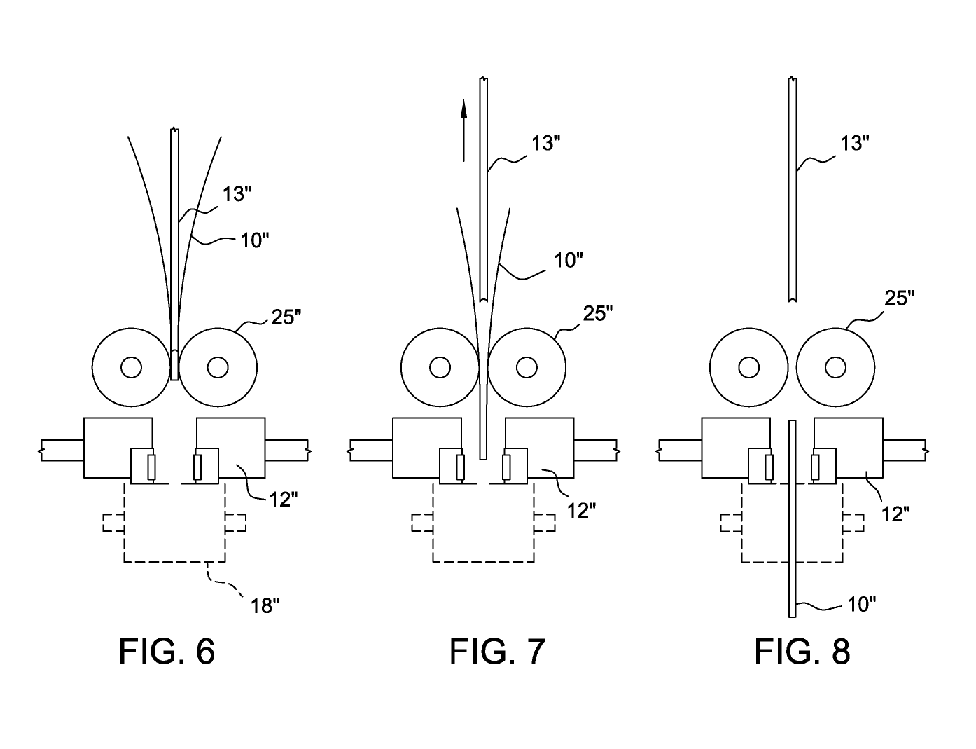

Turning now to FIG. 4, FIG. 5, FIG. 6, FIG. 7, and FIG. 8, there is illustrated a further operational configuration of apparatus embodying the present invention. Similar reference numerals to those employed with reference to FIG. 1, FIG. 2, and FIG. 3 appear in FIG. 4, FIG. 5, FIG. 6, FIG. 7, and FIG. 8. The mode of operation illustrated in FIG. 4, FIG. 5, FIG. 6, FIG. 7, and FIG. 8 is most suitable for the working of a stack comprising in the order of 2-5 sheets of sheet material.

Turning first to FIG. 4, there is provided a schematic view similar to that of FIGS. 1-3 but illustrating only those elements having relevance to this example of the further mode of operation of the invention.

Again, there is illustrated a stack 10″ of sheet material comprising, for example, two sheets, and which stack 10″ is arranged to be folded and compressed so as to form a booklet (as illustrated in FIG. 8 exiting the apparatus).

If desired, the fold rollers 25″ are mounted on their respective axles 26″ in such a way that the roller shown on the left in the drawings is arranged to be driven in a clockwise direction, and the roller on the right in the drawings is arranged to be driven in an anticlockwise direction. The rollers can also be moved close together to impart a pinching/compressive folding action on a stack of sheets. The fold rollers 25″ thus function in this configuration to provide for the folding of the sheets and the fold rollers 25″ can be moved inwardly and outwardly to adjust the gap therebetween. The fold rollers 25″ can also be rotated at any required speed, or restrained from rotating by a variable amount of torque, for example by changing the hold current of a related stepper motor. The fold rollers 25″ can therefore be configured to the required mode by means of two stepper motors. Thus, the fold rollers 25″, with variable relative separation, can be adjusted between mere guiding configurations, and compressive folding configurations, and thereby form basis for the illustrated embodiment of a further mode operation according to the present invention.

As will be appreciated, within this further mode of operation, the jaws 12″ are retained in an open configuration and the folding and forming of the booklet is achieved solely by way of the fold rollers 25″. The fold rollers 25″, which are now rotatable in a driven manner around the axles 26″ are moved towards each other within the direct of Arrow C towards a position of minimum separation as illustrated in FIG. 5. As shown in FIG. 5, blade 13″, which is now arranged to function as a fold blade, has moved downwardly so as to urge a central downwardly deformed portion of the stack 10″ towards the rollers which are arranged to rotate in the manner illustrated by the rotational arrows in FIG. 5. That is, the left hand fold roller 25″ as viewed in FIG. 5 is driven to rotate in a clockwise direction, whereas the right hand fold roller 25″ as viewed in FIG. 5 is driven to rotate in a counter clockwise direction.

As the progressively folding stack 10″ is urged between, and into engagement with, the rotating fold rollers 25″, the rollers serve to grip the folded stack 10″ at which point the downward movement of the fold blade 13″ stops as indicated by FIG. 6.

The fold blade 13″ is then withdrawn upwardly as indicated by the arrow in FIG. 7 whereas the passage of the now folded stack 10″ continues on its downward path through the compressive forces of the driven rotating fold rollers 25″.

As will be appreciated, the compressive force arranged to be exerted by the fold rollers 25″ when in their configuration for gripping and compressing the forming booklet serves to form the required spine of the booklet. The mechanical strength of the spine can be enhanced by use of adhesives etc.

Through continued driven rotation of the fold rollers 25″, the now formed booklet illustrated by 10″ in FIG. 8 can be ejected from the apparatus as required. Such delivery of the completed booklet can be achieved simply by the booklet passing through the rotating fold rollers 25″, or can be further controlled by lateral movement of the fold rollers 25″. That is, relative movement of the fold rollers 25″ away from each other can occur so as to increase the gap of separation therebetween and thus reduce the pinching hold on the booklet, allowing it to continue its downward path and under the influence of gravity if required, to exit the apparatus.

As illustrated with reference to FIG. 8, the fold blade 13″ is then fully retracted upwardly and can await receipt, if required, of a further thin stack 10″ of sheets ready for repeat of the sequence illustrated with reference to FIG. 4, FIG. 5, FIG. 6, and FIG. 7.

Alternatively, if it is determined that a thicker stack of sheets arrives for downward movement by way of the fold blade 13″, the fold rollers 25″ can remain in their guiding configuration of greater separation than in a folding configuration. The fold rollers then function as guide rollers merely to introduce the part folded stack to the jaws 12″ for subsequent compression and folding by the jaws 12″ and, if required, finishing by way of the forming roller 18″ in a manner such as illustrated in FIG. 1, FIG. 2, and FIG. 3.

It will therefore be appreciated that the apparatus of the present invention can perform a booklet forming process in a particularly time-efficient manner irrespective of the thickness of the stack of sheets that arrives for folding. The operation of the apparatus can advantageously reduce the impact of the folding process on other elements, such as the printer, within booklet production apparatus.

As already mentioned, by reshaping the spine of the booklet made, the resulting product will lie flat without appreciable outward bowing of the sheets adjacent the spine, hence facilitating subsequent storage and transportation of the booklets.

Although reference has been made above to the set of sheets 10 being stitched or stapled together before insertion into the forming apparatus, the invention can also be carried out in either mode without the sheets being stitched. In the latter case, the set of sheets can be simply folded or one could use an adhesive, for example a pressure sensitive adhesive, which will secure the sheets together under the pressure which is generated. That would require the application of the adhesive to the sheets before the folded set of sheets is inserted between the clamping jaws.

It should therefore be appreciated that the invention is not restricted to the details of the foregoing embodiments and can be provided in any form of sheet folding apparatus employing a combination of selectively operable fold rollers and clamping jaws.

Although not shown in the drawings, and not described in detail above, the sequence of steps which make up both modes of operation in accordance with the invention can be controlled by an operator or can be part of an automated system after the apparatus has been set up for a particular production run.

1. An apparatus for treating a stack of sheets of sheet material, comprising a means for moving the stack of sheets of sheet material towards a first and second fold roller means, the first and second fold roller means being arranged to assist with folding of the stack of sheets of sheet material, and further comprising a first and second clamping jaws defining a gap therebetween and arranged to be movable relative to each other to increase and decrease the gap for selective application of a clamping force for folding the stack of sheets of sheet material having passed between the first and second fold roller means, wherein the first and second fold roller means are mounted in a manner allowing for a selective increase and decrease in a separation therebetween and thus between a stack-guiding configuration of greater separation and a stack-compressing configuration of lesser separation for folding the stack.

2. An apparatus as claimed in claim 1 wherein the first and second fold roller means are mounted so as to be moveable to vary the separation therebetween.

3. An apparatus as claimed in claim 2 wherein the first and second fold roller means are arranged to be simultaneously and symmetrically moveable relative to a centre of separation.

4. An apparatus as claimed in claim 1 and including a forming roller arranged to move beneath the first and second clamping jaws so as to deform a portion of the stack of sheets of sheet material when clamped in the first and second clamping jaws and extending therefrom.

5. An apparatus as claimed in claim 4 wherein the forming roller is arranged to be moved out of operation when the first and second fold roller means are arranged in the stack-compressing configuration.

6. An apparatus as claimed in claim 1 wherein the means for moving the stack of sheets of sheet material towards the first and second fold roller means comprises a fold blade.

7. An apparatus as claimed in claim 1, wherein the first and second fold roller means and the first and second clamping jaws are mounted for reciprocal movement such that the first and second fold roller means can only be moved into the stack-compressing configuration with the first and second clamping jaws open.

8. An apparatus as claimed in claim 7, and arranged such that the first and second clamping jaws can only be moved to decrease the gap for the selective application of the clamping force when the first and second fold roller means are separated in the stack-guiding configuration.

9. A booklet forming apparatus including an apparatus for treating a stack of sheets of sheet material, the booklet forming apparatus comprising an apparatus, the apparatus comprising a means for moving the stack of sheets of sheet material towards a first and second fold roller means, the first and second fold roller means being arranged to assist with folding of the stack of sheets of sheet material, and further comprising a first and second clamping jaw defining a gap therebetween and arranged to be movable relative to each other to increase and decrease the gap for selective application of a clamping force for folding the stack of sheets of sheet material having passed between the first and second fold roller means, wherein the first and second fold roller means are mounted in a manner allowing for a selective increase and decrease in a separation therebetween and thus between a stack-guiding configuration of greater separation and a stack-compressing configuration of lesser separation for folding the stack.

10. An apparatus as claimed in claim 1, further comprising a sensor means for determining a thickness of the stack of sheets of sheet material.

11. An apparatus as claimed in claim 10, further comprising a control means serving to control a mode of operation of the first and second fold roller means and the first and second clamping jaws responsive to an output signal from the sensor means.

12. A booklet forming apparatus as claimed in claim 9, wherein the first and second fold roller means are mounted so as to be moveable to vary the separation therebetween.

13. A booklet forming apparatus as claimed in claim 12, wherein the first and second fold roller means are arranged to be simultaneously and symmetrically moveable relative to a centre of separation.

14. A booklet forming apparatus as claimed in claim 9, wherein the apparatus further includes a forming roller arranged to move beneath the first and second clamping jaws so as to deform a portion of the stack of sheets of sheet material when clamped in the first and second clamping jaws and extending therefrom.

15. A booklet forming apparatus as claimed in claim 14 wherein the forming roller is arranged to be moved out of operation when the first and second fold roller means are arranged in the stack-compressing configuration.

16. A booklet forming apparatus as claimed in claim 9 wherein the means for moving the stack of sheets of sheet material towards the first and second fold roller means comprises a fold blade.

17. A booklet forming apparatus as claimed in claim 9, wherein the first and second fold roller means and the first and second clamping jaws are mounted for reciprocal movement such that the first and second fold roller means can only be moved into the stack-compressing configuration with the first and second clamping jaws open.

18. A booklet forming apparatus as claimed in claim 17, and arranged such that the first and second clamping jaws can only be moved to decrease the gap for the selective application of the clamping force when the first and second fold roller means are separated in the stack-guiding configuration.

19. A booklet forming apparatus as claimed in claim 9, wherein the apparatus further comprises a sensor means for determining a thickness of the stack of sheets of sheet material.

20. A booklet forming apparatus as claimed in claim 19, wherein the apparatus further comprises a control means serving to control a mode of operation of the first and second fold roller means and the first and second clamping jaws responsive to an output signal from the sensor means.
